(19) United States
(12) Patent Application Publication
(10) Pub. No.: US 2025/0298274 A1
(43) Pub. Date: Sep. 25, 2025

(54) ELECTRO-OPTICAL DEVICE AND ELECTRONIC APPARATUS

(71) Applicant: SEIKO EPSON CORPORATION, Tokyo (JP)

(72) Inventors: Yohei SUGIMOTO, NAGANO-KEN (JP); Kazu KOBAYASHI, KAI-SHI (JP); Mitsuhiro HORIKAWA, SUWA-SHI (JP)

(73) Assignee: SEIKO EPSON CORPORATION, Tokyo (JP)

(21) Appl. No.: 19/082,214

(22) Filed: Mar. 18, 2025

(30) Foreign Application Priority Data
Mar. 19, 2024 (JP) 2024-043242

(51) Int. Cl. G02F 1/1343

(52) U.S. Cl. CPC G02F 1/134309

(57) ABSTRACT

An element substrate of an electro-optical device includes a base portion provided in a non-display region between a display region and a seal material in plan view, a middle portion and an upper portion provided at the base portion, and a shield electrode provided at the element substrate so as to avoid the base portion in plan view, and not in contact with the middle portion and the upper portion. A part of the middle portion and the upper portion has an overhang structure protruding from the base portion in cross-sectional view.

The present application is based on, and claims priority from JP Application Serial Number 2024-043242, filed Mar. 19, 2024, the disclosure of which is hereby incorporated by reference herein in its entirety.

### BACKGROUND

### 1. Technical Field

The present disclosure relates to an electro-optical device and an electronic apparatus.

### 2. Related Art

In an electro-optical device such as a liquid crystal display device for displaying an image, it is known that a liquid crystal layer causes a photochemical reaction due to incidence of light, and a deteriorated product is generated as a reaction product. In addition, it is also known that ions seep into the liquid crystal layer from a seal material for sealing the liquid crystal layer.

In an electro-optical device applied to a projection-type display apparatus for performing display on a large screen, a luminous flux density of incident light is relatively higher as compared to a direct-view-type display device, on the other hand, a pixel size of the electro-optical device is relatively small, so that charged impurities such as deteriorated products and ions tend to adversely affect the display.

For this reason, there has been proposed a technique of moving impurities from a display region to a non-display region by applying AC signals having different phases to electrodes provided in the non-display region (see, for example, JP 2017-78792 A).

However, in the above-described technique, there is a problem in that when a power supply of the electro-optical device is disconnected, the impurities moved to the non-display region return to the display region and deteriorate display quality.

### SUMMARY

In order to solve the above-described problems, an electro-optical device according to an aspect of the present disclosure includes a first substrate and a second substrate disposed facing each other and bonded to each other via a seal material, a liquid crystal layer sandwiched between the first substrate and the second substrate, a pixel electrode provided on the second substrate side of the first substrate in a display region of the first substrate, a counter electrode provided facing the pixel electrode on the first substrate side of the second substrate, a base portion provided in a part of a non-display region between the display region and the seal material in plan view on the second substrate side of the first substrate, a first electrode provided on the second substrate side of the base portion, and a second electrode provided at a position not overlapping the base portion in the non-display region in plan view on the second substrate side of the first substrate, electrically insulated from the first electrode, and applied with a first potential, wherein a part of the first electrode protrudes from the base portion in cross-sectional view, and in a normal direction of the first substrate, a surface on the first substrate side of the first electrode protruding from the base portion is located closer to the second substrate than a surface on the second substrate side of the second electrode.

### BRIEF DESCRIPTION OF THE DRAWINGS

FIG. 1 is a plan view illustrating a configuration of a liquid crystal display device according to a first embodiment.

FIG. 2 is a cross-sectional view of the liquid crystal display device taken along line B-b in FIG. 1.

FIG. 3 is a diagram illustrating an equivalent circuit of a pixel circuit in the liquid crystal display device.

FIG. 4 is a diagram illustrating potentials in data signals and the like in the liquid crystal display device.

FIG. 5 is a plan view illustrating a configuration of a main part of an element substrate in the liquid crystal display device.

FIG. 6 is a plan view illustrating a configuration of a main part of the element substrate in the liquid crystal display device.

FIG. 7 is a partial cross-sectional view illustrating a configuration of a main part of the element substrate in the liquid crystal display device, taken along line C-c in FIG. 5.

FIG. 8 is a diagram simply illustrating a manufacturing process of the liquid crystal display device.

FIG. 9 is a diagram simply illustrating a manufacturing process of the liquid crystal display device.

FIG. 10 is a diagram illustrating capturing of ionic impurities in the liquid crystal display device.

FIG. 11 is a partial cross-sectional view illustrating a configuration of a main part of an element substrate in a liquid crystal display device according to a second embodiment.

FIG. 12 is a diagram illustrating capturing of ionic impurities in the liquid crystal display device.

FIG. 13 is a diagram illustrating a projection-type display apparatus to which the liquid crystal display device is applied.

FIG. 14 is a diagram illustrating capturing of ionic impurities in a liquid crystal display device according to a comparative example.

### DESCRIPTION OF EMBODIMENTS

Hereinafter, an electro-optical device according to embodiments will be described using a liquid crystal display device as an example. Note that in each drawing, dimensions and scales of respective portions are appropriately different from actual ones. Further, since embodiments to be described below are preferred specific examples, various technically preferable limitations are applied, but the scope of the present disclosure is not limited to these embodiments unless it is otherwise stated in the following description that the present disclosure is limited.

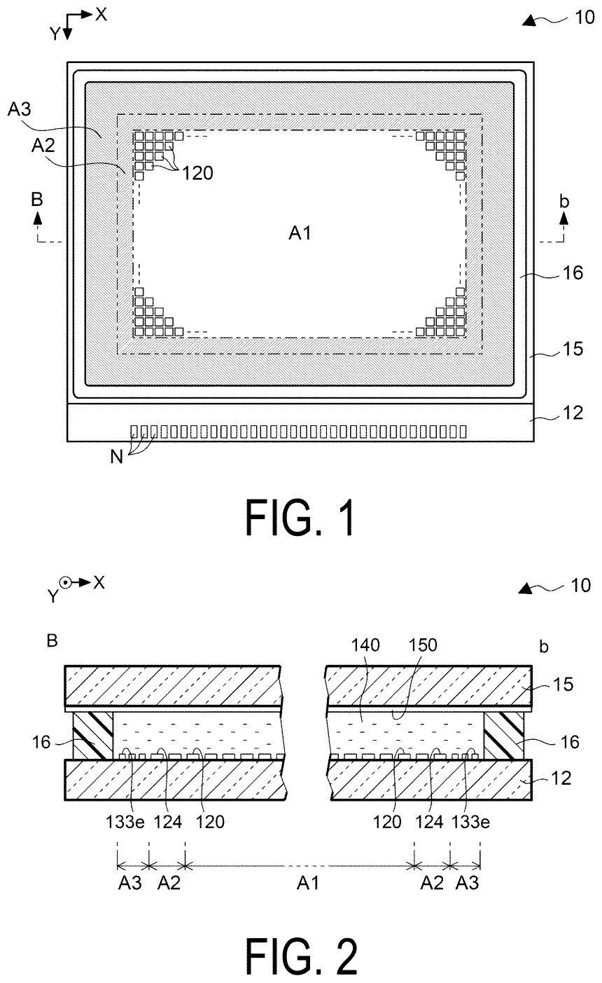

FIG. 1 is a plan view illustrating a configuration of a liquid crystal display device 10 according to a first embodiment, and FIG. 2 is a cross-sectional view of the liquid crystal display device 10 taken along line B-b plane in FIG. 1. As illustrated in FIG. 2, in the liquid crystal display device 10, an element substrate 12 and a counter substrate 15 are bonded to each other while a substantially constant cell thickness is maintained by a seal material 16. For each of the element substrate 12 and the counter substrate 15, a base material having optical transparency and insulation properties, such as glass or quartz, is used.

A plurality of pixel electrodes 120 are provided at a surface of the element substrate 12 facing the counter substrate 15. As illustrated in FIG. 1, the plurality of pixel electrodes 120 are arrayed in a matrix along an X direction and a Y direction in plan view. A region where the plurality of pixel electrodes 120 are arrayed in plan view is a display region A1.

Note that the X direction refers to a longitudinal direction of the rectangular display region A1, and is an extending direction of a scanning line described later. The Y direction refers to a short direction of the rectangular display region A1, and is an extending direction of a data line described later. In addition, plan view means that from one substrate of the element substrate 12 and the counter substrate 15, another substrate is viewed, and specifically, plan view of the element substrate 12 means that the element substrate 12 is viewed from the counter substrate 15.

A surface of the counter substrate 15 facing the element substrate 12 is provided with a counter electrode 150.

A liquid crystal layer 140 is a layer in which liquid crystal is sandwiched between the element substrate 12 and the counter substrate 15. The liquid crystal layer 140 is filled with liquid crystal in which a long axis direction of liquid crystal molecules is aligned in a vertical direction of a substrate surface in a state where no voltage is applied, for example, as in a vertical alignment (VA) method.

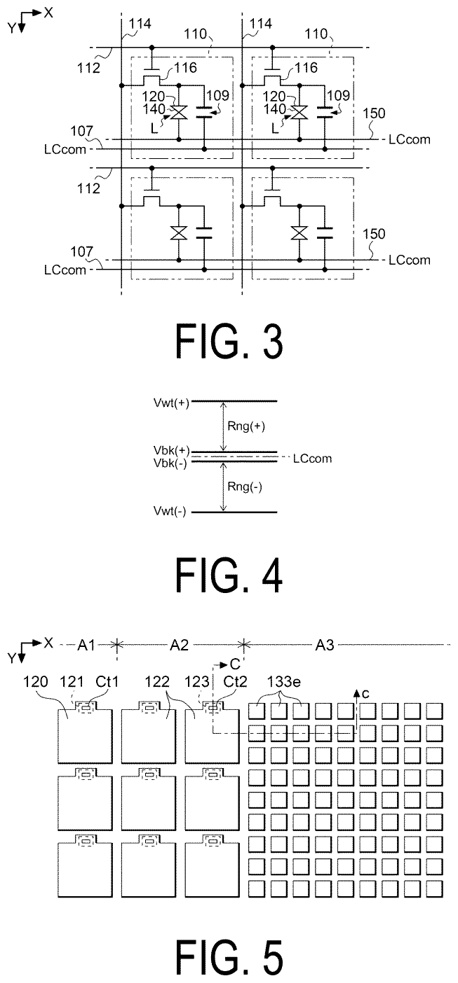

FIG. 3 is a diagram illustrating an equivalent circuit of a pixel circuit in the display region A1. As illustrated in the drawing, pixel circuits 110 are provided corresponding to intersections between a plurality of scanning lines 112 extending in the X direction and a plurality of data lines 114 extending in the Y direction. The pixel circuit 110 includes a transistor 116 and a liquid crystal element L. The transistor 116 is, for example, an N-channel thin film transistor. In the pixel circuit 110, the transistor 116 has a gate node coupled to the scanning line 112, a source node coupled to the data line 114, and a drain node coupled to the pixel electrode 120.

Note that in the present description, “coupling” means direct or indirect coupling or binding between two or more elements, and for example, includes a case in which two or more elements are not directly coupled to each other at a substrate, but are bonded to each other via a different wiring layer and a contact hole.

A potential of the counter electrode 150 facing the pixel electrode 120 is maintained at a potential LCcom that is temporally almost constant. Then, the liquid crystal layer 140 is sandwiched between the pixel electrode 120 and the counter electrode 150. Therefore, for each pixel circuit 110, the pixel electrode 120, the counter electrode 150, and the liquid crystal layer 140 constitute the liquid crystal element L.

A storage capacitor 109 is provided in electrically parallel with the liquid crystal element L. The storage capacitor 109 has one terminal coupled to the pixel electrode 120, and another terminal coupled to a capacitance line 107. A potential of the capacitance line 107 is maintained at a potential that is temporally constant, for example the potential LCcom, similar to the counter electrode 150.

Note that the element substrate 12 is provided with a scanning line drive circuit that supplies a scanning signal to the scanning line 112, a data signal output circuit that outputs a data signal to the data line 114, and the like, which are not illustrated in the drawing. Additionally, as illustrated in FIG. 1, the element substrate 12 is provided with a plurality of terminals N for inputting various signals to the scanning line drive circuit and the data signal output circuit.

The scanning line drive circuit sequentially and exclusively selects the plurality of scanning lines 112 one by one in one frame period, and sets a scanning signal of a selected scanning line 112 to an H level. The data signal output circuit outputs a data signal having a potential corresponding to a gray scale via the data line 114 to the pixel circuit 110 positioned at the scanning line 112 selected by the scanning line drive circuit.

In the pixel circuit 110 corresponding to the scanning line 112 for which a scanning signal is at the H level, the transistor 116 is in an ON state, thus a data signal is applied to the pixel electrode 120 via the data line 114. Even when the scanning signal is at an L level and the transistor 116 is in an OFF state, but a voltage is held by a capacitance of the liquid crystal element L and the storage capacitor 109.

As is well known, in the liquid crystal element L, alignment of liquid crystal molecules changes depending on an electric field generated by the pixel electrode 120 and the counter electrode 150. Therefore, the liquid crystal element L has a transmittance according to an effective value of an applied voltage.

Such operation is similarly performed in the pixel circuit 110 positioned at the selected scanning line 112, and all the liquid crystal elements L in the display region A1 have transmittances corresponding to gray scales by sequentially and exclusively selecting the scanning lines 112 in one frame period. Thus, an image in one frame period is generated.

Note that, in the embodiment, a normally black mode is assumed in which a transmittance is lowest when a voltage applied to the liquid crystal element L is zero, and the transmittance increases as the applied voltage increases.

The liquid crystal element L is driven by alternating current in principle. Specifically, a potential of a data signal is applied while a positive potential on a high potential side and a negative potential on a low potential side are alternately switched with reference to the potential LCcom of the counter electrode 150, for example, for each period of one frame (V).

FIG. 4 is a diagram illustrating a potential range that can be taken by a data signal.

A possible range that can be taken by the positive potential is indicated by Rng (+). The range Rng (+) is, for example, from a potential Vwt (+) when a gray scale has a highest value to a potential Vbk (+) when a gray scale has a lowest value. A possible range that can be taken by the negative potential is indicated by Rng (−). The range Rng (−) is, for example, from a potential Vwt (−) when a gray scale has a highest value to a potential Vbk (−) when a gray scale has a lowest value.

Referring back to FIGS. 1 and 2, non-display regions A2 and A3 are regions on an outer side of the display region A1 and on an inner side of the seal material 16 in plan view. The non-display regions A2 and A3 have frame shapes that surround the display region A1 in order in plan view. That is, in plan view, the non-display region A2 surrounds the display region A1, and the non-display region A3 surrounds the non-display region A2.

A dummy pixel electrode 122 is provided in the non-display region A2, and an upper portion 133e of a columnar body is provided in the non-display region A3. Note that as will be described later, the pixel electrode 120, the dummy pixel electrode 122, and the upper portion 133e are formed of Indium Tin Oxide (ITO) of a third wiring layer formed in the same process.

Note that the non-display regions A2 and A3 are provided with, for example, a light-shielding film at the element substrate 12 and/or the counter substrate 15 in plan view, and thus do not contribute to display. A change from the display region A1 in which the pixel electrodes 120 are arrayed to a region in which the pixel electrodes 120 do not exist may make a difference between the presence and absence of the pixel electrodes appear as a difference in display. For this reason, the dummy pixel electrode 122 is provided to make it difficult for the difference in display to appear.

In addition, a surface of the element substrate 12 facing the counter substrate 15 and a surface of the counter substrate 15 facing the element substrate 12 are each provided with an alignment film that determines alignment of liquid crystal molecules, but illustration thereof is omitted.

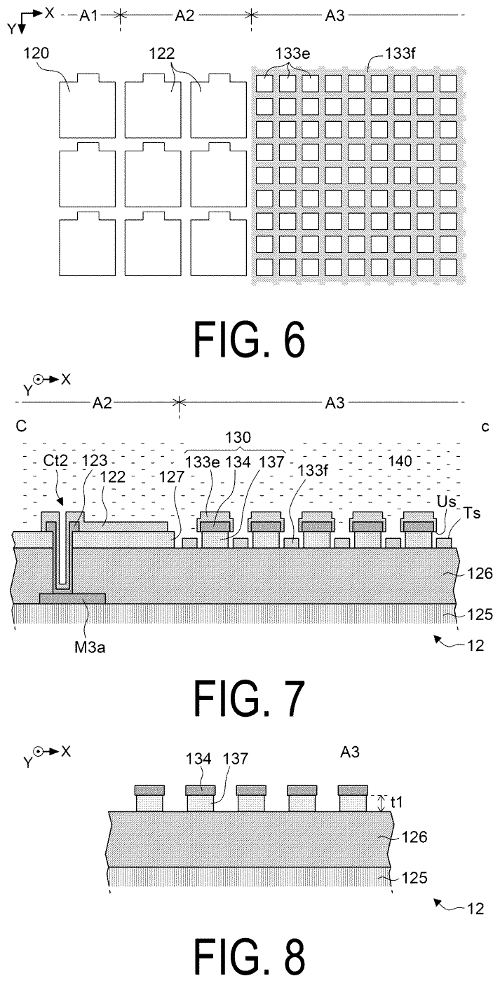

FIG. 5 is a plan view illustrating the configuration of the display region A1 and the non-display regions A2 and A3 on the element substrate 12, in particular, the array of the pixel electrodes 120, the dummy pixel electrodes 122, and the upper portions 133e. FIG. 6 is a plan view illustrating a shield electrode 133f provided in the non-display region A3, and FIG. 7 is a cross-sectional view of a main part of the liquid crystal display device 10 taken along line C-c in FIG. 5.

The pixel electrode 120 in the display region A1 is coupled to a drain node of the transistor 116 via a coupling electrode 121 filled in a contact hole Ct1. Note that the pixel electrode 120 has a substantially square shape in plan view.

The dummy pixel electrode 122 in the non-display region A2 have the same configuration as that of the pixel electrode 120 in the display region A1 except that a coupling destination is different. Specifically, in the dummy pixel electrode 122, a coupling destination via a coupling electrode 123 filled in a contact hole Ct2 is a separate wiring line M3a different from the drain node of the transistor 116. Note that in the embodiment, the wiring line M3a is in a floating state of being not electrically coupled to any portion.

The upper portion 133e in the non-display region A3 is an element at an uppermost layer among elements constituting a columnar body 130. A shape of the upper portion 133e is substantially square as with the pixel electrode 120 and the dummy pixel electrode 122, but a length of one side is shorter than one sides of the pixel electrode 120 and the dummy pixel electrode 122.

In the non-display region A3 of the element substrate 12, the shield electrode 133f is provided in addition to the columnar body 130.

As indicated by hatching in FIG. 6, the shield electrode 133f is provided in a region in the non-display region A3 except for the upper portions 133e in plan view. In other words, the shield electrode 133f is provided in a mesh shape extending in the X direction and the Y direction in plan view in the non-display region A3 so as to surround the upper portions 133e. The shield electrode 133f appears to be in contact with the upper portion 133e in plan view, but is not actually in contact with the upper portion 133e due to a level difference described below. Also, the shield electrode 133f is not in contact with the dummy pixel electrode 122 in the non-display region A2. Note that, the shield electrode 133f is applied with, for example, the potential Vwt (−) when a gray scale has the highest value in negative polarity through wiring (not illustrated).

FIG. 7 illustrates three insulating layers close to the liquid crystal layer 140 among a plurality of insulating layers provided at the element substrate 12 and three wiring layers. Note that a base material of the element substrate 12 is present on a lower side in FIG. 7. In addition, the display region A1 is omitted in FIG. 7.

Among the elements illustrated in FIG. 7, the insulating layers will be referred to as a first insulating layer, a second insulating layer, and a third insulating layer in order from the base material in order to distinguish the insulating layers, and the wiring layers will be referred to as a first wiring layer, a second wiring layer, and a third wiring layer in order from the base material in order to distinguish the wiring layers.

Note that the first wiring layer is, for example, a metal wiring layer made of aluminum or the like, and the second wiring layer and the third wiring layer are alloy wiring layers made of ITO or the like having transparency and conductivity.

As illustrated in the drawing, the first wiring layer is formed at an insulating layer 125 which is the first insulating layer as a film, and the wiring line M3a is provided by patterning the first wiring layer. An insulating layer 126 which is the second insulating layer is provided so as to cover the insulating layer 126 and the wiring line M3a. Further, the third insulating layer is provided so as to cover the insulating layer 126.

The third insulating layer contains boron (B) and phosphorus (P) and is a moisture-proof layer for preventing moisture from entering the liquid crystal layer 140. The third insulating layer is not patterned and becomes an insulating layer 127 as is in the display region Al and the non-display region A2, but is patterned and becomes a base portion 137 of the columnar body 130 in the non-display region A3.

In the non-display region A2, the contact hole Ct2 opens the insulating layers 126 and 127. Note that also in the display region Al, the contact hole Ct1 is provided as illustrated in FIG. 5.

After the contact holes Ct1 and Ct2 are provided, the second wiring layer is formed as a film. The second wiring layer formed as a film is patterned and becomes the coupling electrode 121 in the display region A1, becomes the coupling electrode 123 in the non-display region A2, and becomes a middle portion 134 in the non-display region A3.

The middle portion 134 is patterned into a shape larger than the base portion 137 in plan view, specifically, into a shape including the base portion 137. For this reason, a part of the middle portion 134 protrudes from the base portion 137 in cross-sectional view to form a so-called overhang structure. Note that the term “cross-sectional view” refers to a view obtained by breaking a substrate along a vertical direction of a substrate surface, that is, along a normal direction of a substrate surface of a first substrate.

After the middle portion 134 is provided, the third wiring layer is formed as a film. The third wiring layer formed as a film is patterned in the display region A1 and the non-display region A2, but is not patterned in the non-display region A3. Specifically, the third wiring layer becomes the pixel electrode 120 in the display region A1 and becomes the dummy pixel electrode 122 in the non-display region A2 by patterning, but is separated into the upper portion 133e and the shield electrode 133f by not being patterned in the non-display region A3.

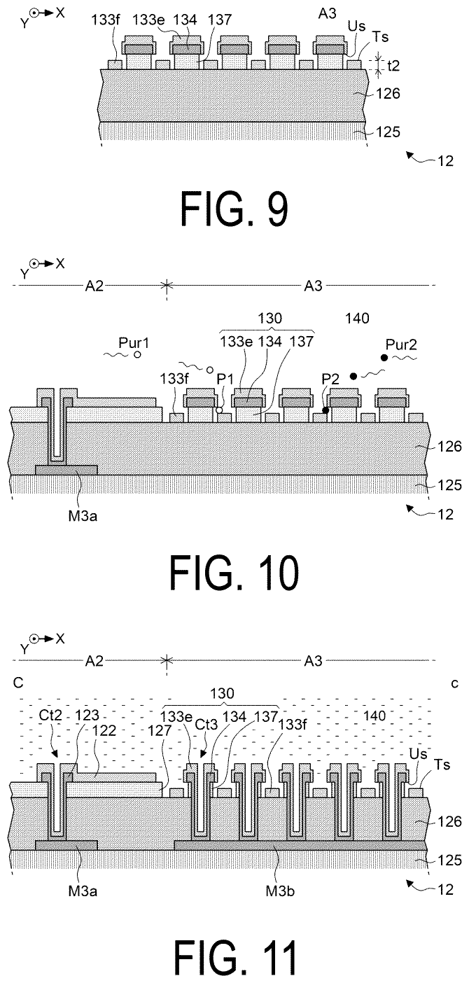

This will be described with reference to FIGS. 8 and 9.

FIGS. 8 and 9 are diagrams for simply explaining the formation of the upper portion 133e and the shield electrode 133f.

As illustrated in FIG. 8, in the non-display region A3, the base portion 137 is provided at an upper surface of the insulating layer 126 by patterning the third insulating layer. A thickness of the base portion 137, that is, the third insulating layer, is defined as t1.

Further, the middle portion 134 is provided at an upper surface of the base portion 137 by patterning the second wiring layer.

Next, the third wiring layer is provided by film formation using a vapor deposition source in an upward direction in FIG. 9. The third wiring layer is deposited at an upper surface and a side surface of the middle portion 134 and an exposed portion of the insulating layer 126 where the base portion 137 is not formed. Here, a thickness of the third wiring layer is defined as t2.

The middle portion 134 has the overhang structure with respect to the base portion 137, thus when the third wiring layer is formed as a film with a vapor deposition source in the upper direction, the third wiring layer is not deposited at a portion of the exposed portion of the insulating layer 126 that is a shadow of the middle portion 134. In other words, the third wiring layer is formed as a film in a self-aligned manner at the exposed portion of the insulating layer 126 with the middle portion 134 as a mask.

The thickness t1 of the base portion 137 is larger than the thickness t2 of the third wiring layer, thus a lower surface Us of the upper portion 133e protruding from the base portion 137 in the upper portion 133e is located at a position away from an upper surface Ts of the shield electrode 133f formed of the third wiring layer with reference to the base material of the element substrate 12. In other words, when viewed from the counter substrate 15, the upper surface Ts is located at a position closer than the shield electrode 133f.

For this reason, the upper portion 133e is cut off from the shield electrode 133f of the potential Vwt (−) and is brought into a floating state.

Here, before describing effects of the liquid crystal display device 10 according to the first embodiment, capturing of impurities such as deteriorated products and ions by a comparative example will be described.

FIG. 14 is a cross-sectional view of a main part of a liquid crystal display device according to the comparative example in the non-display region A2 in which the dummy pixel electrode 122 is provided in plan view and a region outside the non-display region A2, that is, a region corresponding to the non-display region A3 in the first embodiment. In other words, FIG. 14 is a diagram illustrating a portion corresponding to FIG. 7 in the first embodiment.

As illustrated in FIG. 14, in the comparative example, a shield electrode 133g formed of the same layer as the dummy pixel electrode 122 is provided in the region outside the non-display region A2. As in the first embodiment, the shield electrode 133g is applied with the potential Vwt (−) via wiring (not illustrated). In the comparative example, during a power-on period, that is, during a period in which display operation is performed, the counter electrode 150 is applied with the potential LCcom and the shield electrode 133g is applied with the potential Vwt (−), so that an electric field is generated in a vertical direction of the substrate, that is, a normal direction of the substrate.

For this reason, a deteriorated product Pur 1 which is a reaction product of the liquid crystal layer 140 or the like is attracted by a region where the electric field is generated and is adsorbed by the shield electrode 133f. Further, an ion Pur 2 bled through the seal material 16 is also adsorbed by the shield electrode 133g.

When the power supply is off, that is, when the display operation is completed, no electric field is generated, so that the adsorbed deteriorated product Pur 1 and ion Pur 2 are released and return to the display region. The deteriorated product Pur 1 and the ion Pur 2 returning to the display region cause a deterioration in display quality.

On the other hand, the first embodiment differs from the comparative example as follows.

FIG. 10 is a cross-sectional view of a main part for explaining capturing of impurities in the liquid crystal display device 10 according to the first embodiment.

The first embodiment is also common to the comparative example in that the counter electrode 150 is applied with the potential LCcom, and the shield electrode 133f is applied with the potential Vwt (−) during the power-on period, and thus an electric field is generated in the vertical direction of the substrate.

The deteriorated product Pur 1, which is a reaction product of the liquid crystal layer 140 or the like, is attracted by the non-display region A3 where an electric field is generated, and is adsorbed by the shield electrode 133f. In addition, the point that the ion Pur 2 bled through the seal material 16 is adsorbed by the shield electrode 133f in the non-display region A3 is also common to the comparative example.

However, in the first embodiment, the deteriorated product Pur 1 and the ion Pur 2 adsorbed by the shield electrode 133f are maintained in the adsorbed state by the middle portion 134 and the upper portion 133e overhanging with respect to the base portion 137 even when the power source is turned off, that is, even when the display operation is completed and the electric field is not generated. For this reason, it is possible to suppress a decrease in display quality caused by the adsorbed deteriorated product Pur 1 and ion Pur 2 moving to the non-display region A2 and further to the display region A1.

In the first embodiment, the upper portion 133e is in the floating state, thus only a relatively weak electric field is generated between the counter electrode 150 and the shield electrode 133f in the non-display region A3 during the power-on period. Therefore, it has to be said that force of attracting the deteriorated product Pur 1 and the ion Pur 2 to the shield electrode 133f is relatively weak.

Therefore, a second embodiment in which this point is improved will be described.

FIG. 11 is a cross-sectional view of a main part of the liquid crystal display device 10 according to the second embodiment, and is a diagram taken along line C-c in FIG. 5, similarly to FIG. 7.

As illustrated in the drawing, in the second embodiment, in the non-display region A3, a wiring line M3b is provided between the insulating layers 125 and 126 by patterning the first wiring layer. The wiring line M3b is coupled to the capacitance line 107, for example. Therefore, the wiring line M3b is applied with the potential LCcom, as in the case of the counter electrode 150.

In addition, in the non-display region A3, a contact hole Ct3 that opens the insulating layer 126 and the base portion 137, and exposes the wiring line M3b is provided for each columnar body 30. Although the middle portion 134 is provided by film formation and patterning of the second wiring layer as in the first embodiment, in the second embodiment, the middle portion 134 is filled in the contact hole Ct3 and coupled to the wiring line M3b. The third wiring layer becomes the upper portion 133e at the upper surface of the middle portion 134, and is formed as a film in a self-aligned manner at the exposed portion of the insulating layer 126 using the middle portion 134 as a mask to become the shield electrode 133f.

Note that in the second embodiment, the upper portion 133e and the middle portion 134 are coupled to the wiring line M3b via the contact hole Ct3. Therefore, the second embodiment is common to the first embodiment in that the shield electrode 133f has the potential Vwt (−), but is different from the first embodiment in that the upper portion 133e and the middle portion 134 are not floating but have the potential LCcom.

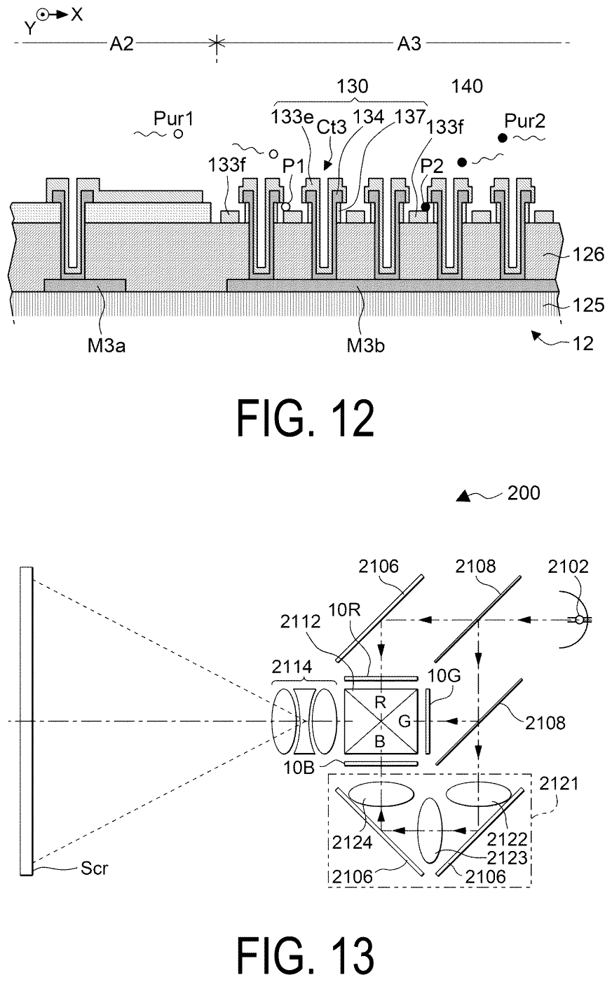

FIG. 12 is a cross-sectional view of a main part for explaining capturing of impurities in the second embodiment.

During the power-on period, the counter electrode 150 is applied with the potential LCcom, but the upper portion 133e and the middle portion 134 are also supplied with the potential LCcom, therefore, a stronger electric field is generated between the upper portion 133e and the middle portion 134 and the shield electrode 133f applied with the potential Vwt (−) as compared with the first embodiment.

The deteriorated product Pur 1 is attracted from the non-display region A2 where no electric field is generated to the non-display region A3 where a strong electric field is generated, and is adsorbed by the shield electrode 133f. In addition, the ion Pur 2 exuded from the seal material 16 is also attracted in the non-display region A3 where the strong electric field is generated, and is adsorbed by the shield electrode 133f.

The deteriorated product Pur 1 and the ion Pur 2 adsorbed by the shield electrode 133f are maintained in the adsorbed state by the middle portion 134 and the upper portion 133e overhanging with respect to the base portion 137 even when the power source is turned off, that is, even when display operation is completed and an electric field is not generated. For this reason, even in the second embodiment, it is possible to suppress a decrease in display quality caused by the adsorbed deteriorated product Pur 1 and ion Pur 2 moving to the non-display region A2 and further to the display region A1.

Note that in the second embodiment, the configuration is adopted in which the upper portion 133e and the middle portion 134 are supplied with the potential LCcom via the wiring line M3b. Since it is sufficient that an electric field is generated between the upper portion 133e and the middle portion 134 and the shield electrode 133f, a configuration may be adopted in which the upper portion 133e and the middle portion 134 are supplied with a potential different from the potential Vwt (−) of the shield electrode 133f.

The element substrate 12 is an example of a “first substrate”, the counter substrate 15 is an example of a “second substrate”, the upper portion 133e is an example of “first electrode”, the shield electrode is an example of a “second electrode”, and the potential LCcom is an example of a “first potential”.

Next, a projection-type display apparatus will be described as an example of an electronic apparatus in which the liquid crystal display device 10 described in the embodiment or the like is used.

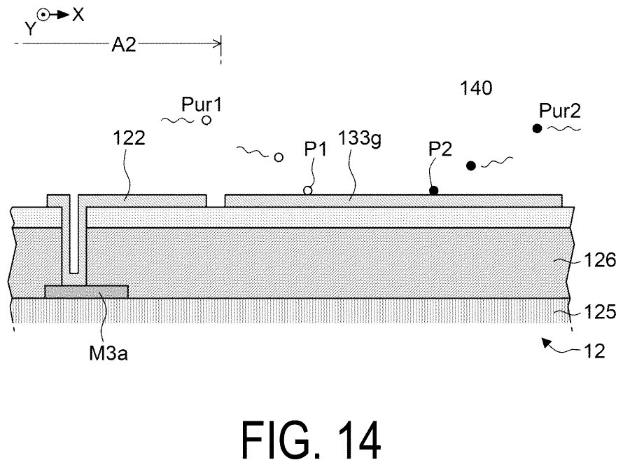

FIG. 13 is a diagram illustrating an optical configuration of a projection-type display apparatus 200. As illustrated in the drawing, the projection-type display apparatus 200 includes liquid crystal display devices 10R, 10G, and 10B. The projection-type display apparatus 200 contains a lamp unit 2102 including a white light source such as a halogen lamp. Light emitted from the lamp unit 2102 is split into three primary colors of red (R), green (G), and blue (B) by three mirrors 2106 and two dichroic mirrors 2108 disposed at an inside. Of the primary colors, light of R, light of G, and light of B are incident on the liquid crystal display device 10R, the liquid crystal display device 10G, and the liquid crystal display device 10B, respectively.

Note that an optical path of the light of B is longer than those of the light red and green. Therefore, the light of B is guided to the liquid crystal display device 10B via a relay lens system 2121 formed of an incidence lens 2122, a relay lens 2123, and an emission lens 2124 to prevent a loss in the optical path.

The liquid crystal display device 10R generates an R transmitted image by being driven based on a data signal corresponding to R. Similarly, the liquid crystal display device 10G generates a G transmitted image based on a data signal corresponding to G, and the liquid crystal display device 10B generates a B transmitted image based on a data signal corresponding to B.

The transmitted color images generated by the corresponding liquid crystal display devices 10R, 10G, and 10B enter a dichroic prism 2112 from three directions. Then, at the dichroic prism 2112, the light of R and the light of B are refracted at 90 degrees, whereas the light of G travels in a straight line. Accordingly, the images of the respective colors are synthesized, and subsequently a color image is projected on a screen Scr by a projection lens 2114.

Note that the electronic apparatus including the electro-optical device such as the liquid crystal display device 10 can be applied not only to the projection-type display apparatus 200 but also to a head-mounted display, an electronic viewfinder in a video camera, a lens-interchangeable digital camera, or the like, a display unit of a smartwatch or a wearable device, or the like.

The following aspects, for example, can be ascertained from the embodiments or the like explained above. Hereinafter, in order to facilitate understanding of each of the aspects, the reference signs of the drawings are provided in parentheses for convenience, but the present disclosure is not intended to be limited to the illustrated aspects.

An electro-optical device (10) according to one Aspect 1 includes a first substrate (12) and a second substrate (15) disposed facing each other and bonded to each other via a seal material (16), a liquid crystal layer (140) sandwiched between the first substrate (12) and the second substrate (15), a pixel electrode (120) provided on the second substrate (15) side of the first substrate (12) in a display region (A1) of the first substrate (12), a counter electrode (150) provided facing the pixel electrode (120) on the first substrate (12) side of the second substrate (15), a base portion (137) provided in a part of a non-display region (A3) between the display region (A1) and the seal material (16) in plan view on the second substrate (15) side of the first substrate (12), a first electrode (134, 133e) provided on the second substrate (15) side of the base portion (137), a second electrode (133f) provided at a position not overlapping the base portion (137) in the non-display region (A3) in plan view on the second substrate (15) side of the first substrate (12), electrically insulated from the first electrode (134, 133e), and applied with a first potential, wherein a part of the first electrode (134, 133e) protrudes from the base portion (137) in cross-sectional view, and in a normal direction of the first substrate (15), a surface on the first substrate (12) side of the first electrode (134, 133e) protruding from the base portion (15) is located closer to the second substrate (15) than a surface on the second substrate (15) side of the second electrode (133f).

According to the electro-optical device according to Aspect 1, impurities are adsorbed by the second electrode by an electric field generated by applying the first potential to the second electrode. Even when the electric field disappears due to power-off or the like, movement of the impurities adsorbed by the second electrode is inhibited by the first electrode protruding from the base portion, so that a deterioration in display quality due to the impurities is suppressed.

In the electro-optical device (10) according to specific Aspect 2 of Aspect 1, the first electrode (134, 133e) is in an electrically floating state.

In the electro-optical device (10) according to specific Aspect 3 of Aspect 1, the first electrode (134, 133e) is applied with a potential different from the first potential (LCcom).

In the electro-optical device (10) according to specific Aspect 4 of Aspect 1, the first electrode (134, 133e) and the second electrode (133f) are made of the same material.

In the electro-optical device (10) according to specific Aspect 5 of Aspect 4, the first electrode (134, 133e) and the second electrode (133f) have transparency.

The electro-optical device (10) according to another specific Aspect 6 of Aspect 1 includes a dummy pixel electrode (122) that is provided in a region (A2) between the display region (A1) and a region (A3) in which the second electrode (133f) is provided in plan view and that has the same shape as the pixel electrode (120).

In the electro-optical device (10) according to another specific Aspect 7 of Aspect 1, the base portion (137) has insulating properties, and the second electrode (133e) surround the base portion (137) in plan view.

An electronic apparatus (200) according to Aspect 8 includes the electro-optical device (10) according to any one of Aspects 1 to Aspect 7.

What is claimed is:

1. An electro-optical device, comprising:
a first substrate and a second substrate disposed facing each other and bonded to each other via a seal material;
a liquid crystal layer sandwiched between the first substrate and the second substrate;
a pixel electrode provided on the second substrate side of the first substrate in a display region of the first substrate;
a counter electrode provided facing the pixel electrode on the first substrate side of the second substrate;
a base portion provided in a part of a non-display region between the display region and the seal material in plan view on the second substrate side of the first substrate;
a first electrode provided on the second substrate side of the base portion; and
a second electrode provided at a position not overlapping the base portion in the non-display region in plan view on the second substrate side of the first substrate, electrically insulated from the first electrode, and applied with a first potential, wherein
a part of the first electrode protrudes from the base portion in cross-sectional view, and
in a normal direction of the first substrate, a surface on the first substrate side of the first electrode protruding from the base portion is located closer to the second substrate than a surface on the second substrate side of the second electrode.

2. The electro-optical device according to claim 1, wherein
the first electrode is in an electrically floating state.

3. The electro-optical device according to claim 1, wherein
the first electrode is applied with a potential different from the first potential.

4. The electro-optical device according to claim 1, wherein
the first electrode and the second electrode include the same material.

5. The electro-optical device according to claim 4, wherein
the first electrode and the second electrode have transparency.

6. The electro-optical device according to claim 1, further comprising a dummy pixel electrode provided in a region between the display region and a region where the second electrode is provided in plan view and having the same shape as the pixel electrode.

7. The electro-optical device according to claim 1, wherein
the base portion has an insulating property, and
the second electrode surrounds the base portion in plan view.

8. An electronic apparatus comprising the electro-optical device according to claim 1.
